(19) United States
(12) Patent Application Publication
(10) Pub. No.: US 2016/0125155 A1
(43) Pub. Date: May 5, 2016

(54) MOBILE APPLICATION FOR REPORTING WORKPLACE INJURIES AND/OR FOR CONSULTING FOR EMPLOYEE/PERSONAL HEALTHCARE ISSUES

(71) Applicant: Paul Shelter, Buffalo, NY (US)

(72) Inventor: Paul Shelter, Buffalo, NY (US)

(21) Appl. No.: 14/928,968

(22) Filed: Oct. 30, 2015

Related U.S. Application Data
(60) Provisional application No. 62/073,070, filed on Oct. 31, 2014.

(51) Int. Cl. G06F 19/00; H04M 3/56; H04N 5/76; H04N 7/14

(52) U.S. Cl. CPC G06F 19/3418; H04N 7/141; H04M 3/56; H04N 5/76; G06Q 50/22

(57) ABSTRACT

A mobile application for reporting and consulting regarding workplace injuries, illnesses or other health related issues. The application is configured to remotely connect a triage specialist with a first user and a second user. The application sends notification to the second user that a call is in place between the first user and the triage specialist, and is configured to allow the second user to join the video conference. The triage specialist may receive identification and location information from the first user, and the triage specialist may provide the first user with an assessment of an injury or illness, and send to the first user location information related to a medical provider. The application is configured to generate and send triage reports and recorded video to the second user. In one embodiment, the first user is an employee and the second user is a safety manager affiliated with an employer.

### RELATED APPLICATIONS

This application claims priority from provisional application No. 62/073,070, which was filed on Oct. 31, 2014, and is hereby incorporated by reference in its entirety.

### TECHNICAL FIELD

The present invention relates generally to a mobile application for reporting workplace injuries or illnesses telephonically and/or through live video chat and for automating storage and retrieval of audio and video files relating to healthcare triage services.

### BACKGROUND ART

Healthcare triage services and call centers for consulting with nurses or other medical staff regarding health/injury issues are known. Automated triage systems and methods are disclosed in U.S. Pat. Nos. 8,346,573; 7,668,733; and 7,720,692.

### BRIEF SUMMARY OF THE INVENTION

With parenthetical reference to the corresponding parts, portions or surfaces of the disclosed embodiment, merely for the purposes of illustration and not by way of limitation, the present invention provides a mobile application for reporting and consulting regarding workplace injuries, illnesses, or other health related issues for users of the application. The system running the application includes a plurality of client devices (12A-N) with graphical user interfaces (14A-N), a web application server (16), and a company database (18); coupled via a network (15), according to one embodiment.

In another aspect, an automated triage system for remotely connecting a first user with a second user and a triage specialist is disclosed. The system comprises a computer having a processor, a memory, and a communications system. The computer is connected to a network. The processor is configured to call the triage specialist in response to a request made by the first user through an application programmed on the computer and to send a notification to the second user that the call between the first user and the triage specialist is in progress. The system is configured to allow the second user to join the call between the first user and the triage specialist and to provide first user information including a time and an identification and a location of the first user to the triage specialist. The system is configured to receive triage information including an injury assessment or illness assessment of the first user from the triage specialist, to generate a triage report based on the first user information and the triage information, and to provide the generated triage report to the second user. While the preferred embodiment relates to workplace injuries and illnesses, the automated triage system may be further configured to handle personal injuries and illnesses, by connecting a personal user of the system with a virtual triage specialist, and further by sending system-generated reports to the personal user.

The disclosed system may further comprise the computer having a video recorder, wherein the processor is further configured to record video of the first user during the call, and in response to a determination that the call has ended, upload the video via the network to a location accessible by the second user. The triage specialist may start, stop, and pause the video recording of the first user during the call. The processor may be further configured to receive, from the triage specialist, medical provider information including a name and a location of the medical provider, in addition it being configured to send the triage report to the medical provider. The application may play an emergency situation disclaimer message in response to the first user starting the application, and the call to the triage specialist may be placed automatically in response to the first user acknowledging the emergency situation disclaimer message. In one embodiment, the first user is an employee and the second user is a safety manager affiliated with an employer of the first user. In additional embodiments, the first user has a personal injury or illness, and the second user may be a person designated by the first person, for instance a primary care physician.

In another aspect, provided is a method of providing an automated triage system for remotely connecting a first user with a second user and a triage specialist. The method comprises providing a computer having a processor, a memory, and a communications system. The computer is connected to a network. The method includes the step of calling, via the computer, the triage specialist in response to a request made by the first user through an application programmed on the computer, and sending a notification to the second user that the call between the first user and the triage specialist is in progress. The system is configured to allow the second user to join the call between the first user and the triage specialist, and to provide first user information including a time and an identification and a location of the first user to the triage specialist. The method includes receiving triage information including an injury assessment or illness assessment of the first user from the triage specialist and generating a triage report based on the first user information and the triage information. The method may also include providing the generated triage report to the second user.

In another aspect, provided is a non-transitory computer readable medium comprising a set of instructions for providing an automated triage system. The instructions are executable by a computer having a processor and a memory. The set of instructions direct the processor to perform the acts of connecting to a network and a mobile communications system, calling a triage specialist in response to a request made by a first user through an application programmed on the computer, and sending a notification to a second user that the call between the first user and the triage specialist is in progress. The system is configured to allow the second user to join the call between the first user and the triage specialist and to provide first user information including a time and an identification and a location of the first user to the triage specialist. The system is configured to receive triage information including an injury assessment or illness assessment of the first user from the triage specialist and to generate a triage report based on the first user information and the triage information. The system may also provide the generated triage report to the second user.

### BRIEF DESCRIPTION OF THE DRAWINGS

FIG. 1 is a block diagram of a plurality of client devices with user interfaces, a web application server, and a company database; coupled via a network, according to one embodiment; and,

FIG. 2 is a flowchart/system diagram showing a preferred embodiment of a method of using the disclosed automated triage system.

FIG. 3 is a flowchart/system diagram showing the operation of the automated triage system and related mobile application, web service, and portal.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read together with the specification, and are to be considered a portion of the entire written description of this invention.

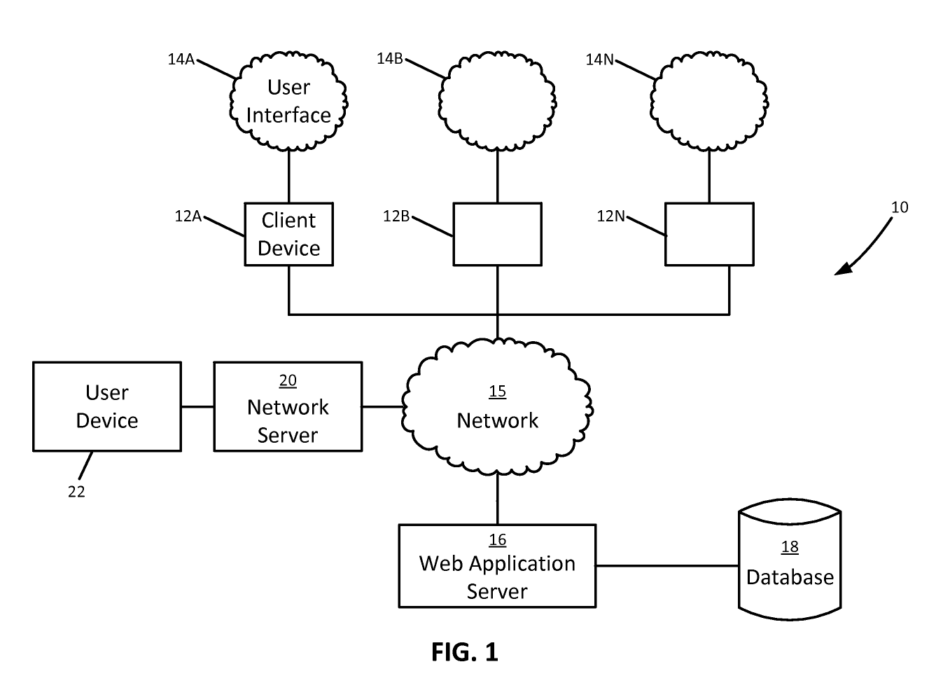

Referring now to the drawings, FIG. 1 illustrates a block diagram 10 of a plurality of client devices 12A-N with user interfaces 14A-N, a web application server 16, and a structured database 18, coupled via a network 15, according to one embodiment. More than one web application server 16, and structured database 18 may be coupled to the network 15. Only one of each is shown in FIG. 1 for clarity.

The plurality of client devices 12A-N may be any system, device, and/or any combination of devices/systems that are able to establish a connection with another device, a server and/or other systems. The client devices 12A-N typically include display or other output functionalities to present data exchanged between the device and a user. For example, the client devices may be, but are not limited to, a server, a desktop computer, a computer cluster, a mobile computing device such as a notebook, a laptop computer, a handheld computer, a mobile phone, a smart phone, or a PDA. In particular, the Google Android software platform allows developers to write software applications to integrate third party applications with users of mobile devices, and Apple also allows third party applications developers access to the iPhone platform. In one embodiment, client devices 12A-N are each coupled to the network 15. In some embodiments, the client devices may be directly connected to one another.

The network 15, to which the client devices 12A-N are coupled, may be a telephonic network, an open network, such as the Internet, or a private network, such as an intranet and/or the extranet. The network 15 may be any collection of distinct networks operating wholly or partially in conjunction to provide connectivity to the client devices and servers, and may appear as one or more networks to the serviced systems and devices. In one embodiment, communications may be achieved by a secure communications protocol, such as secure sockets layer (SSL), or transport layer security (TLS). In one embodiment, communications may be achieved via one or more wireless networks. In one embodiment, the mobile application is coupled with the web application server 16 via the Internet using a REST protocol API.

A mobile telephone network server 20 may be any combination of software agents and/or hardware modules for establishing a mobile telephone network for users. The mobile telephone network server 20 may facilitate interaction and communication among users of the client devices 12A-N, with the web application server 16 or with other related applications and/or systems via the network 15. The mobile telephone network server 20 supports a device 22 which may be a tablet, cellular phone, or the like that is provided with the app of the present invention.

The client devices 12A-N may be coupled to the network, for example, the internet, via a dial-up connection, a digital subscriber loop (DSL, ADSL), cable modem, and/or other types of connection. Thus, the client devices 12A-N may communicate with remote servers (e.g., web server, host server, mail server, and instant messaging server) that provide access to user interfaces of the World Wide Web via a web browser, for example.

The structured database 18 may store information such as software, descriptive data, images, system information, drivers, and/or any other data item utilized by parts of the mobile telephone network server 20, and/or the web application server 16 for operation. Database 18 may be managed by a database management system (DBMS), for example but not limited to, Oracle, DB2, Microsoft Access, Microsoft SQL Server, PostgreSQL, MySQL, FileMaker, etc.

The web application server 16 may be any combination of software agents and/or hardware modules for automatically storing and organizing video and audio files in the structured database 18 or on the server 16. The web application server 16 generates automatic notices via text or e-mail, provides for uploading audio and video in storage, and authorizes and administers access to the files via an authorized user portal.

A user may initially download and install an automated triage application (or “app”) associated with the disclosed system and method onto their device. For instance, a user may be directed to browse an app store with their smartphone device, where they can download a software program that will connect them with the disclosed triage web portal and triage web services. In other embodiments, a user may be provided with a link to a triage web portal, from where the associated application can be directly downloaded onto their device. The same download location may be used to provide application updates to a user, and the system may be configured to update automatically on a user device.

After downloading and installing the triage app, the user may then register themselves and/or their device. Such registration may preferably be accomplished by a user entering an employee identifier and passphrase. Employee identifier examples include the user's name, an employee ID number, e-mail address, social security number, or the like. Passphrases are preferably entered by (and unique to) each user, though alternatively may be provided by an employer or other client.

According to a preferred embodiment of the disclosure, an employee user of the disclosed automated triage system will provide authorization to the employer to collect and store the information compiled by the disclosed system, as described in greater detail below. Authorization may be given in writing, e.g. contained in an employee handbook, which the employee will acknowledge having read and agree to the terms therein. Authorization may also be built into the terms and conditions of the triage software application, which a user of the system will have to agree to upon initial registration.

While the preferred embodiment relates to workplace injuries and illnesses, the automated triage system may be further configured to handle personal injuries and illnesses. For example, a personal user of the system may be connected directly with a virtual triage specialist, and all system-generated reports may be sent directly to the personal user. In such a case, notification to a second user of the system is not required. In additional embodiments, the first personal user may designate a second user to receive notifications and/or reports. For example, a personal user may wish to designate a family member or primary care physician as an individual configured to receive notifications and/or reports, as disclosed herein.

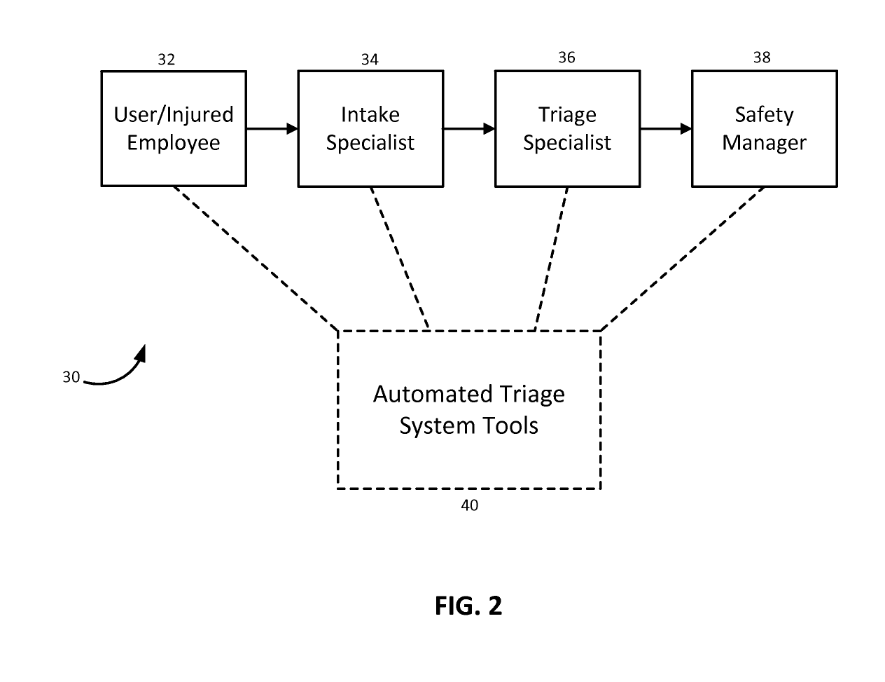

Turning to FIG. 2, a user 32 is preferably trained by an employer to download an automated triage mobile application to their device 22, and further to register themselves in automated triage system 30, according to the methods described herein. User 32 is further trained to open said application upon sustaining an injury or illness in the workplace environment. When user 32 opens the app on their device 22, an initial screen will include a warning to dial 911 in the event of an emergency. Said warning may take the form of a pre-recorded video, audio, or text message and/or disclaimer instructing user 32 to call 911 in the event of an emergency. Preferably, user 32 will be unable to proceed to the next step in the process without first acknowledging that they are not involved in an emergency, either by actively attesting to the fact (such as by selecting an acknowledgement button), or by listening to/reading the entirety of a pre-recorded message.

After the emergency warning phase, the next screen of the triage app may include a button labeled “Call Triage Center” (or similar) that will activate a suite of automated triage system tools 40. In other embodiments, the “Call Triage Center” button will activate automatically upon an application within system 30 reaching the end of the emergency warning or receiving the proper acknowledgement. When the “Call Triage Center” feature is activated, system 30 will then proceed to contact intake specialist 34, the details of the contacting procedure being based on the type of device 22 that user 32 is utilizing. For instance, if using an Android device, a triage app may be configured to a) record the session start time; b) open the device dialer and initiate a call to intake specialist 34; c) reopen the app; and, d) send a message to application web server 16 to initially notify a point of contact, such as employer safety manager 38. Similarly, for a device running iOS, a triage app may be alternatively configured to a) record the session start time; b) open a dialer where user 32 can authorizes a call to intake specialist 34; c) show a notification to redirect user 32 back to the triage app; and d) send a message to application web server 16 to initially notify the associated point of contact. The point of contact on record may be a safety manager, vice president of safety, general manager, or the like, and the notification method can be via e-mail, text message, phone call, or any other similar form of notification. Additionally, multiple notifications may be sent to different individuals, each notification being tailored to that specific person. For instance, a safety manager of user 32 may be provided with a link to join a call in progress, while a supervisor of user 32 may simply receive general notification of an incident occurrence. In other embodiments, user 32 may designate a specific individual that is to receive notifications, for instance a family member or primary care physician. System 30 may be further configured to bypass notifications all together, allowing user 32 to privately connect with intake specialist 34.

When a call is initiated, video chat is preferred over voice-only, and video will be activated as a default. System 30 may also monitor the available bandwidth and automatically determine if video or a voice call will be used. User 32 may also have an option to toggle “Wi-Fi only” mode, wherein video chat will only be used when device 22 is connected to a Wi-Fi signal, or else the call will default to voice-only, which may be useful in saving user 32 from using up available data on a cellular plan, or in the event that user 32 does not have a cellular data plan associated with device 22. A recording of the video call and/or voice call will preferably be saved on device 22 or in database 18 linked to web application server 16 until such time when the recording is uploaded to a web portal or other storage system under the control of an employer of user 32.

In order to sufficiently document the process disclosed herein related to injuries or illnesses sustained in the workplace, system 30 is preferably configured to record the entirety of the conversation between user 32 and any of intake specialist 34, triage specialist 36, and safety manager 38. In alternative embodiments, one of user 32, intake specialist 34, or triage specialist 36 may press a “Record Injury” (or similar) button, which will trigger the recording of the video of device 22, while the others on the call may or may not have access to the recording controls. Such a configuration may be useful in the event that user 32 is not able to conduct a video chat (if, for example, they do not have access to a Wi-Fi network at their location), user 32 may still record and document an injury or illness, the video of which may be saved locally to device 22, and the video may later be uploaded to a server accessible by the employer at another time (for instance, once a Wi-Fi connection is established with device 22). The app may be configured to open a preview window showing the camera point of view (i.e., what will be recorded). System 30 stores the video or telephone call locally on the device 22 until the session ends. After the session ends, system 30 will attempt to send the video or audio files to the web portal application programming interface (“API”). Similar to the data transfer options discussed above, user 32 has the ability to configure system 30 to transmit the session via a 4G cellular connection, Wi-Fi connection to the Internet, or the like. Device 22 will store the session on a local storage disk until the interface with the API successfully connects the device to the web application server 16 for transmission of the files.

Intake specialist 34 is provided to receive calls from multiple users of system 30. In a preferred embodiment, intake specialist 34 will open up an individual video conference with each user 32 calling into the triage center, and has the ability to place a plurality of users into a queue in the event that multiple calls are in progress at any given moment. Identifying information associated with each user 32 will be provided for the intake specialist 34 to review, for instance the employee's name, company, and current location. The location of user 32 may be obtained via the GPS system of user device 22, and presented to intake specialist 34 on a map-based interface by pressing a “Show Location” button. In other embodiments, intake specialist 34 may not be provided with a user 32 location by default, but may have the ability to request access to the GPS signal of user 32 by pressing a “Request Location” button. Intake specialist 34 is preferably able to provide live translation services for user 32 if needed, either directly or by facilitating translation through a third-party service, while the call is in progress. Once connected with user 32, intake specialist 34 may make a determination as to whether user 32 should be connected with a triage specialist 36, and if so, facilitate said connection. Intake specialist 34 may be located remotely from both user 32 and triage specialist 36, while in other embodiments, intake specialist 34 may be bypassed altogether, allowing user 32 to connect directly with triage specialist 36. In such a case, triage specialist 36 would be further tasked with performing the above-referenced responsibilities of intake specialist 34.

Once a determination is made to connect user 32 with triage specialist 36, intake specialist 34 will preferably inform user 32 that additional help is forthcoming, and subsequently contact triage specialist 36. User 32 may be placed on hold and returned to the caller queue of intake specialist 34 at this time. Intake specialist 34 may also choose one triage specialist 36 from a plurality of available specialists, basing a decision on factors such as availability/wait time, specialty, injury/illness type or severity, or the like.

After intake specialist 34 facilitates connecting user 32 with triage specialist 36, intake specialist 34 will preferably leave the call. Similar to the conference between user 32 and intake specialist 34, the conference between user 32 and triage specialist 36 will preferably occur via video chat, subject to the same options related to user 32 video/bandwidth settings as discussed above. Triage specialist 36 will preferably have access to the same identifying information as intake specialist 34, for instance the employee's name, company, and current location.

Triage specialist 36 is preferably tasked with performing an initial assessment of the injury sustained or illness contracted by user 32 and recommending a course of action. One potential recommended course of action may be to refer user 32 to a third-party medical provider such as a hospital, clinic, urgent care center, or the like. System 30 will preferably be pre-loaded with information related to these medical providers located near user 32. Accordingly, triage specialist 36 can preferably use the tools of system 30 to push a provider's information (e.g. name, location, phone number, etc) directly onto user device 22. This functionality would, for instance, allow user 32 to easily pull up driving directions to a recommended health provider on their device 22. System 30 is also preferably configured to generate and send reports directly to the chosen medical provider, so that said provider has access to information regarding the initial assessment of user's 32 injury and/or illness, prior to the on-site arrival of user 32. Such coordination and reporting serves to decrease the intake time of user 32 at the provider as well as increase the quality of care received. These reports are preferably electronically delivered (via e-mail, web portal, etc) to the medical provider using state of the art encryption techniques, thus protecting the personal information of user 32. Additionally, system 30 may be preloaded with the health insurance information of user 32, the employer of user 32, or both, so that triage specialist 36 may coordinate his/her medical provider recommendation accordingly (for instance, by directing user 32 to an in-network provider instead of an out-of-network provider).

As discussed above, a call to the triage center by user 32 will preferably trigger an initial notification to be sent to a corresponding employer safety manager 38, giving said safety manager 38 the option of joining an in-progress call along with user 32 and triage specialist 36. System 30 is preferably setup to allow 3-way calling between user 32, triage specialist 36, and safety manager 38, but is further capable of supporting any number of individuals joining a call in progress. If safety manager 38 is not available to join the session, the call will still proceed between user 32 and triage specialist 36. However, there are many benefits to the inclusion of an employer representative such as safety manager 38. Initially, safety manager 38 will be provided with details related to an injury or illness of user 32 very quickly, such that safety manager 38 may be able to take immediate action to help prevent other employees from suffering similar injuries. Further, safety manager 38 will be able to quickly receive information directly from triage specialist 36 related to the severity of the injury sustained or illness contracted by user 32, including an estimate of how long user 32 might be unable to work, in addition to any potential limitations as to the type of tasks that user 32 may be able or unable to perform. Such discussions between user 32, triage specialist 36, and safety manager 38 may further extend to a discussion of potential alternative work availability (regarding both the type of work and/or worksite location). This coordination between employer, employee, and healthcare professional has the potential to save a significant amount of time and effort on behalf of all parties.

In additional embodiments, system 30 may be configured for user 32 to connect with triage specialist 36 outside of the scope of an employer-employee setting, for instance when sustaining a personal injury or contracting a personal illness outside of work. In such cases, user 32 may choose another individual (in place of safety manager 38, as described herein) to receive notifications and/or reports. For example, user 32 may wish to designate a family member or primary care physician to receive notifications and reports of any correspondence with between user 32 and triage specialist 36. Further embodiments provide for system 30 to bypass notifications all together, allowing user 32 to connect privately with triage specialist 36. In such configurations, system 30 may send any reports directly to user 32.

Throughout the correspondence between user 32, triage specialist 36, and safety manager 38, system 30 is configured to protect the personal health information of user 32, in compliance with the privacy and security rules and guidelines outlined and governed by the Health Insurance Portability and Accountability Act (HIPAA). In particular, automated triage system tools 40 will preferably include functionality for triage specialist 36 to be able to stop/pause/resume recording as well as mute the audio of a call, in order to prevent any protected information from being saved and sent to the employer database. Triage specialist 36 further has the ability to temporarily place on hold any person other than user 32 (such as if safety manager 38 has joined the conference). In the event that protected information is inadvertently recorded (or anticipated to be recorded), triage specialist 36 will preferably be able to “tag” or “mark” the video and/or audio recording at specific times, enabling the recording to be easily edited before being sent off to the company's portal. Such editing is preferably automated by system 30 by deleting any recorded information located between a “start tag” and an “end tag” as placed by triage specialist 36, however the recorded information may also be edited manually by triage specialist 36 before the recorded information is released. An additional embodiment of system 30 provides for a “delayed recording” feature, wherein the recording of audio/video is delayed by a certain amount of time as compared to the live conference (for instance, a delay may be set to 10 seconds or some similar amount of time). Accordingly, triage specialist 36 may pause/mute the recording after any protected information is disclosed by the employee, but prior to that protected information being saved by system 30 for subsequent upload to the employer.

At the conclusion of the call, the user 32 may press a “Hang Up” button, whereby the app returns to the startup screen. The video or audio session and the time are recorded by system 30. The call information is sent to the web portal application programming interface along with audio and/or video files, if recorded. Final notifications may also be sent according to the configuration of system 30. Similar to the initial notification method previously discussed, system 30 may be configured to notify multiple people of an incident, with each notification tailored to a specific individual. For instance, an employer vice president of safety may be provided with notification containing all system- and user-generated reports with notice that saved audio/video recordings are now accessible, while a supervisor of user 32 may receive general notification of an incident.

Much of the reporting functionality is handled automatically by system 30. Triage reports will be generated based on information entered into system 30 by triage specialist 36 (such as initial assessment, corrective actions prescribed, secondary medical instructions given, referrals, etc), as well as information taken from user 32 and/or system 30 (such as employee identification, GPS location, time and date, and the like). System 30 is further able to parse data from the triage report to create incident reports and/or regulatory reports, as required by the employer. At the request of user 32 and/or triage specialist 36, system 30 may further be configured to send customized reports directly to secondary healthcare providers, for instance urgent care centers. Reports will be secured and made available to authorized users immediately upon completion/submission. System 30 may additionally be configured to allow multiple layers of access to the generated reports and/or saved video/audio files. For instance, an employer supervisor may be given access to incident reports for the employees serving under them, while a Vice President of Safety may be given access to all reports and video recordings for all employees of the company.

Triage specialist 36 is preferably a licensed health practitioner such as a registered nurse or physician's assistant, trained in the visual assessment of illnesses and acute workplace injuries. However, triage specialist 36 is not limited to this role or specialty. Automated triage system 30 may additionally by configured wherein, instead of being confined to an employer-employee relationship, user 32 is in need of personal services, ambulatory or otherwise. Examples of such services may include psychiatric, pediatric, veterinary, breastfeeding, or other similar services, and triage specialist 36 may similarly be a physician, psychiatrist, pediatrician, veterinarian, healthcare consultant, risk management specialist, or other similar provider of services. In such alternative embodiments, it is possible for system 30 to be configured to generate and provide custom reports directly to user 32, for instance via e-mail or private web portal.

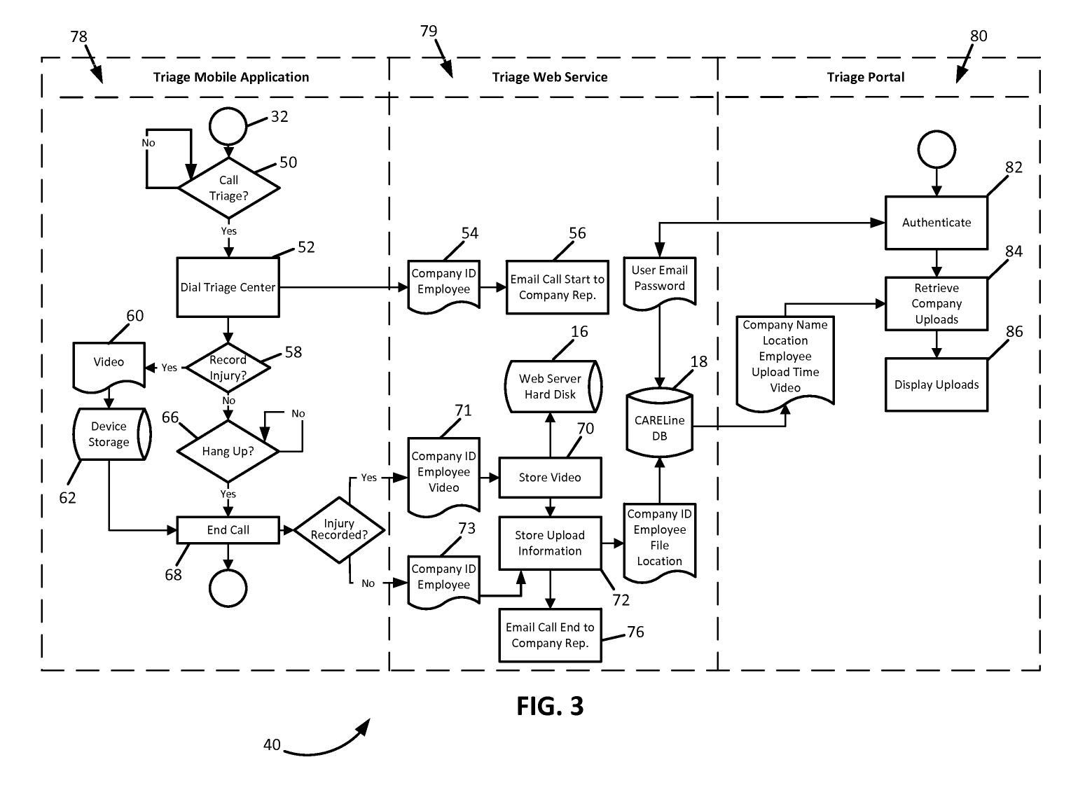

Turning to FIG. 3, the operation of the automated triage system tools 40 are now discussed in further detail, in particular with regards to the operation of triage mobile application 78, triage web service 79, and triage portal 80.

In step 50, user 32 (e.g. an employee that has sustained an injury or contracted an illness within the workplace environment) selects whether to press the “Call Triage” button on the graphical user interface of triage mobile application 78 associated with user's 32 mobile device 22. If user 32 presses the “Call Triage” button, system 30 automatically dials a Triage Center in step 52 and sends information 54 including company identification and the identity of the employee to the web application server 16. In step 56, the web application server 16 automatically generates and sends an e-mail or similar notification to a designated company representative such as a vice president of safety, safety manager, foreman, or the like. The e-mail notifies the company representative that a call has been initiated and invites the representative to join the call in progress. As discussed above, the Triage Center may be a call center staffed by medical intake specialists and nurses or other medically trained staff (e.g., doctors, nurses, physicians assistants, persons trained in first aid, etc.), while the intake and triage specialists may alternatively be located remotely from each other. The Triage Center provides live communication with a person having medical training that can provide appropriate advice regarding the treatment of an injury and/or illness condition including whether further treatment at a hospital, urgent care center, or doctor's office is advisable or if the injury/condition may be treated with first aid and over the counter medications.

In step 58, a decision is made whether to record the injury or medical condition. If user 32 presses the “Record Injury” button on their user interface, triage mobile application 78 sends the video file 60 to local storage disk 62 on user's 32 device 22. Once the recording is complete or if user 32 decides not to record the injury or illness, the call may be ended by user 32 pressing a “Hang Up” button in step 66.

After the call is terminated in step 68, if a video recording has been made, triage mobile application 78 transmits company identification, employee identification and video recording 71 to web application server 16. Video files are stored on the web application server 16 in step 70. Triage web service 79 stores upload information including the company identification, employee identification, and file location on the structured database 18 in step 72. The structured database 18 is accessible to authorized users as described in detail herein.

If there is no video recording, then triage web service 79 transmits company identification and employee identification 73 to be stored in web application server 16 or in structured database 18 in step 72.

Once the call is concluded and all of the information has been transmitted to web application server 16, triage web service 79 sends additional notifications as needed, for instance an e-mail or text message in step 76 to the company representative indicating that the call has ended.

At the conclusion of the call, all of the audio and video files are associated with a company identification and an employee and stored on the web application server 16 and/or the structured database 18 for later retrieval by authorized users.

A web portal 80 provides for authorized access by company representatives or other authorized users to videos and audio that have been uploaded to system 30, as discussed in detail above. In step 82, an authorized user is authenticated, for instance by submitting their email address and password to the portal 80. Once authenticated, the authorized user can retrieve the company uploads in step 84 and can display the company uploads for review in step 86. The uploaded audio and video files are preferably tagged with identifying information such as the company name, the location, the employee name, and the upload time.

The present invention contemplates that many changes and modifications may be made. Therefore, while the presently-preferred form of the system has been shown and described, and several modifications and alternatives discussed, persons skilled in this art will readily appreciate that various additional changes and modifications may be made without departing from the spirit of the invention, as defined and differentiated by the following claims.

1. An automated triage system for remotely connecting a first user with a second user and a triage specialist, comprising:
a computer having a processor, a memory, and a communications system, the computer connected to a network, wherein the processor is configured to:
call the triage specialist in response to a request made by the first user through an application programmed on the computer;
send a notification to the second user that the call between the first user and the triage specialist is in progress, wherein the system is configured to allow the second user to join the call between the first user and the triage specialist;
provide, to the triage specialist, first user information including a time and an identification and a location of the first user; and,
receive, from the triage specialist, triage information including at least one of an injury assessment and an illness assessment of the first user.

2. The automated triage system of claim 1, further comprising:
the computer having a video recorder, and wherein the processor is further configured to:
record video of the first user during the call, and
in response to a determination that the call has ended, upload the video via the network to a location accessible by the second user.

3. The automated triage system of claim 2, further comprising:
the triage specialist having an ability to start, stop, and pause the video recording of the first user during the call.

4. The automated triage system of claim 1, further comprising:
the processor further configured to receive, from the triage specialist, medical provider information including a name and a location of the medical provider.

5. The automated system of claim 4, further comprising:
the processor further configured to generate a triage report based on the first user information and the triage information.

6. The automated triage system of claim 5, further comprising:
the processor further configured to provide the triage report to the medical provider.

7. The automated triage system of claim 5, further comprising:
the processor further configured to provide the triage report to the second user.

8. The automated triage system of claim 1, further comprising:
wherein the application is configured to play an emergency situation disclaimer message in response to the first user starting the application.

9. The automated triage system of claim 8, further comprising:
wherein the call to the triage specialist is placed automatically in response to the first user acknowledging the emergency situation disclaimer message.

10. The automated triage system of claim 1, further comprising:
wherein the first user is an employee and wherein the second user is a safety manager affiliated with an employer of the first user.

11. The automated triage system of claim 1, further comprising:
wherein the first user designates a specific individual as the second user.

12. A method of providing an automated triage system for remotely connecting a first user with a second user and a triage specialist, comprising:
providing a computer having a processor, a memory, and a communications system, the computer connected to a network,
calling, via the computer, the triage specialist in response to a request made by the first user through an application programmed on the computer;
sending a notification to the second user that the call between the first user and the triage specialist is in progress, wherein the system is configured to allow the second user to join the call between the first user and the triage specialist;
providing, to the triage specialist, first user information including a time and an identification and a location of the first user; and,
receiving, from the triage specialist, triage information including at least one of an injury assessment and an illness assessment of the first user.

13. The method of providing an automated triage system of claim 12, further comprising:
providing the computer with a video recorder,
recording video of the first user during the call,
providing the triage specialist with an ability to start, stop, and pause the video recording of the first user during the call, and
in response to a determination that the call has ended, uploading the video via the network to a location accessible by the second user.

14. The method of providing an automated triage system of claim 12, further comprising:
receiving, from the triage specialist, medical provider information including a name and a location of the medical provider,
generating a triage report based on the first user information and the triage information, and
providing the triage report to the medical provider and the second user.

15. The method of providing an automated triage system of claim 12, further comprising:
playing an emergency situation disclaimer message in response to the first user starting the application, and
calling the triage specialist automatically in response to the first user acknowledging the emergency situation disclaimer message.

16. The method of providing an automated triage system of claim 12, further comprising:
wherein the first user is an employee and wherein the second user is a safety manager affiliated with an employer of the first user.

17. A non-transitory computer readable medium comprising a set of instructions for providing an automated triage system, the instructions executable by a computer having a processor and a memory, the set of instructions to direct the processor to perform the acts of:
connecting to a network and a mobile communications system,
calling a triage specialist in response to a request made by a first user through an application programmed on the computer;
sending a notification to a second user that the call between the first user and the triage specialist is in progress, wherein the system is configured to allow the second user to join the call between the first user and the triage specialist;
providing, to the triage specialist, first user information including a time and an identification and a location of the first user; and,
receiving, from the triage specialist, triage information including at least one of an injury assessment and an illness assessment of the first user.

18. The non-transitory computer readable medium of claim 16, further comprising:
providing the computer with a video recorder,
recording video of the first user during the call,
providing the triage specialist with an ability to start, stop, and pause the video recording of the first user during the call, and
in response to a determination that the call has ended, uploading the video via the network to a location accessible by the second user.

19. The non-transitory computer readable medium of claim 16, further comprising:
receiving, from the triage specialist, medical provider information including a name and a location of the medical provider,
generating a triage report based on the first user information and the triage information, and
providing the triage report to the medical provider and the second user.

20. The non-transitory computer readable medium of claim 16, further comprising:
playing an emergency situation disclaimer message in response to the first user starting the application, and
calling the triage specialist automatically in response to the first user acknowledging the emergency situation disclaimer message.

21. The non-transitory computer readable medium of claim 16, further comprising:
wherein the first user is an employee and wherein the second user is a safety manager affiliated with an employer of the first user.
